(19) United States
(12) Patent Application Publication
(10) Pub. No.: US 2025/0287325 A1
(43) Pub. Date: Sep. 11, 2025

(54) ENHANCED ACCESS TRAFFIC STEERING, SWITCHING AND SPLITTING (ATSSS) TRIGGER FOR POWER LIMITED USER EQUIPMENT (UE)

(71) Applicant: Cable Television Laboratories, Inc., Louisville, CO (US)

(72) Inventor: Sundar R. Sriram, Aurora, CO (US)

(21) Appl. No.: 19/073,929

(22) Filed: Mar. 7, 2025

Related U.S. Application Data
(60) Provisional application No. 63/562,535, filed on Mar. 7, 2024.

(51) Int. Cl. H04W 52/36; H04W 28/08; H04W 80/02

(52) U.S. Cl. CPC H04W 52/365; H04W 28/08; H04W 80/02

(57) ABSTRACT

Various systems, apparatuses, and methods for dynamically adapting one or more access traffic steering, switching, and splitting (ATSSS) policies based on a power headroom (PHR) of a user equipment (UE) are provided. A method performed by a base station is provided. The base station receives the PHR from the UE. The base station determines a power headroom of the UE based on the received PHR. When the determined power headroom falls below a threshold power headroom for a predefined duration, the base station determines that the UE enters a power-limited state. The base station transmits, to a core network (CN), a first indication that the UE is in the power-limited state. After transmitting the first indication, the base station receives a first set of updated ATSSS policies from the CN. The base station transmits the first set of updated ATSSS policies to the UE.

### CROSS REFERENCE TO RELATED APPLICATIONS

This application claims the benefit of U.S. provisional application No. 63/562,535 filed on Mar. 7, 2024 which is incorporated by reference as if fully set forth.

### BACKGROUND OF THE INVENTION

Access traffic steering, switching, and splitting (ATSSS) is a feature in fifth generation (5G) networks that enables devices to utilize both third generation partnership project (3GPP) and non-3GPP accesses simultaneously. A core network (5GC) provides one or more ATSSS policies to distribute traffic across the 3GPP and non-3GPP accesses simultaneously. Conventional ATSSS procedure is primarily designed to optimize the traffic distribution based on factors such as network availability, congestion, and quality of service (QoS) requirements etc. Conventional ATSSS policies do not consider any power limitations of the devices. As a result, even when the devices are in a power-limited state, the conventional ATSSS policies may continue to steer traffic through power consuming accesses, thereby affecting device performance. Therefore, there is a need for power-aware traffic management and ATSSS policy updates.

### SUMMARY OF THE INVENTION

In various implementations, a method performed by a base station is provided. The method comprises receiving a power headroom report (PHR) from a user equipment (UE). The UE is associated with a set of access traffic steering, switching and splitting (ATSSS) policies. The method comprises determining, based on the received PHR, a power headroom of the UE. The method comprises, on a condition that the determined power headroom is less than a first threshold power headroom, transmitting, to a core network (CN), a first indication that the UE is in a power limited state. The method comprises receiving, from the CN, a first set of updated ATSSS policies for the UE based on the first indication.

In an implementation, the method comprises transmitting the first set of updated ATSSS policies to the UE.

In an implementation, the method comprises, on a condition that the determined power headroom is not less than the first threshold power headroom. The method comprises transmitting, to the CN, a second indication that the UE is not in the power limited state. The method comprises receiving a second set of updated ATSSS policies for the UE based on the second indication.

In an implementation, the method comprises transmitting the second set of updated ATSSS policies to the UE.

In an implementation, the PHR is received from the UE using a media access control (MAC) control element (MAC CE).

In an implementation, PHR reporting is triggered by one or more of: a path loss change greater than a threshold path loss change, or a periodic timer event.

In an implementation, the UE is connected to the CN by a third generation partnership project (3GPP) access and a non-3GPP access.

In an implementation, the UE is associated with a multi-access protocol data unit (MA PDU) session using the 3GPP access and the non-3GPP access.

In an implementation, the first set of updated ATSSS policies prioritize the non-3GPP access when the UE is in the power limited state.

In an implementation, the method comprises determining that the UE is in the power limited state based on a PHR trigger event.

In an implementation, the method comprises monitoring the power headroom of the UE for a predefined duration.

In an implementation, the method comprises determining that the UE enters the power limited state when the power headroom is less than the first threshold power headroom for the predefined duration.

In an implementation, the method comprises determining that the UE exits the power limited state when the power headroom is not less than the first threshold power headroom for the predefined duration.

In an implementation, the method comprises receiving, from the UE, an indication for one or more of: the UE is ATSSS-enabled UE, or the UE uses a UE-assistance indicator for adjusting traffic.

In various implementations, a base station comprising a transceiver and a processor is provided. The transceiver and the processor are configured to receive a PHR from a UE. The UE is associated with a set of ATSSS policies. The transceiver and the processor are configured to determine, based on the received PHR, a power headroom of the UE. The transceiver and the processor are configured to, on a condition that the determined power headroom is less than a first threshold power headroom, transmit, to a CN, a first indication that the UE is in a power limited state. The transceiver and the processor are configured to receive, from the CN, a first set of updated ATSSS policies for the UE based on the first indication.

In an implementation, the transceiver and the processor are further configured to transmit the first set of updated ATSSS policies to the UE.

In an implementation, the transceiver and the processor are further configured to, on a condition that the determined power headroom is not less than the first threshold power headroom, transmit, to the CN, a second indication that the UE is not in the power limited state. The transceiver and the processor are further configured to receive a second set of updated ATSSS policies for the UE based on the second indication.

In an implementation, the transceiver and the processor are further configured to transmit the second set of updated ATSSS policies to the UE.

In an implementation, the PHR is received from the UE using a MAC CE.

In an implementation, PHR reporting is triggered by one or more of: a path loss change greater than a threshold path loss change, or a periodic timer event.

In an implementation, the UE is connected to the CN by a 3GPP access and a non-3GPP access.

In an implementation, the UE is associated with a MA PDU session using the 3GPP access and the non-3GPP access.

In an implementation, the first set of updated ATSSS policies prioritize the non-3GPP access when the UE is in the power limited state.

In an implementation, the transceiver and the processor are further configured to monitor the power headroom of the UE for a predefined duration.

In an implementation, the transceiver and the processor are further configured to determine that the UE enters the power limited state when the power headroom is less than the first threshold power headroom for the predefined duration.

In an implementation, the transceiver and the processor are further configured to determine that the UE exits the power limited state when the power headroom is not less than the first threshold power headroom for the predefined duration.

In an implementation, the transceiver and the processor are further configured to receive, from the UE, an indication for one or more of: the UE is ATSSS-enabled UE, or the UE uses a UE-assistance indicator for adjusting traffic.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and 5G core (5GC);

FIG. 4 illustrates an example of a protocol stack for a user plane and a control plane;

FIG. 5 is a flowchart illustrating a process for access traffic steering, switching and splitting (ATSSS) trigger for a power limited user equipment (UE) according to one or more embodiments;

FIG. 6 is an example system diagram of an ATSSS architecture according to one or more embodiments; and

FIG. 7 is an example flow diagram of a method of transmitting a set of ATSSS policies to a UE according to one or more embodiments.

### DETAILED DESCRIPTION OF THE PREFERRED EMBODIMENTS

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which mayor may not be integrated with the processor and/or transceiver), button (e.g., for controlling the specific function of one or more aspects of the device). These components may be operably connected to one another, meaning that there may be a direct connection or an indirect connection to one or more of the components.

A UE may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

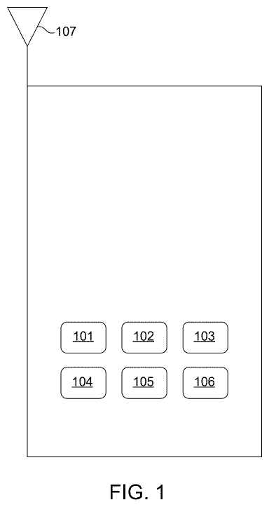

FIG. 1 is an illustration of an example device. In one case, the device may be a User Equipment (UE) suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous (e.g., different timing/spacing for UL or DL).

Different radio access technologies may be used with one or more transceivers (e.g., 802.11, WCDMA, CDMA2000, GSM, LTE, LTE-A, LTE-A Pro, NR etc.).

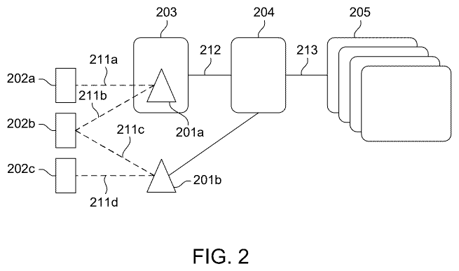

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

Generally, a communication system may use a combination of wired and wireless connections at different points in the system. One or more wireless technologies may (e.g., channel access methods), may include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network 206, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QoS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same RAT as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMF, one or more UPF, one or more Session Management Function (SMF), and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

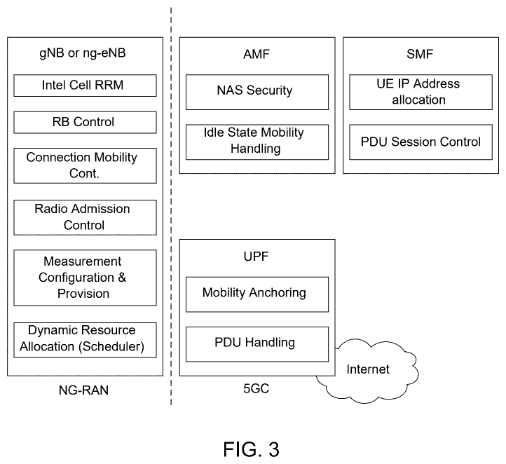

FIG. 3 illustrates an example of a functional split between the NG-RAN and 5GC. The AMF may be connected to one or more gNB the RAN via an N2 interface and may serve as a control node. For example, the AMF may be responsible for authenticating a support of the UE for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

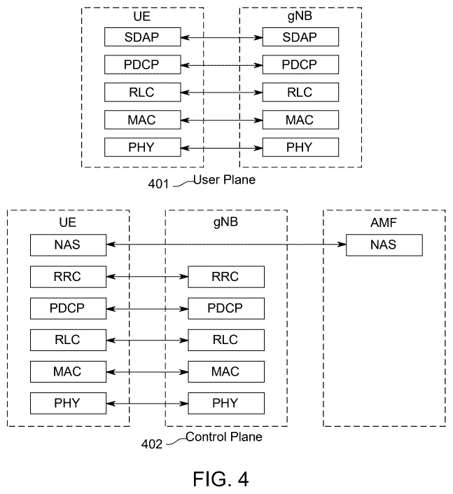

FIG. 4 illustrates an example of a protocol stack for the user plane and control plane. The user plane protocol stack 401 and the control plane stack 402. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

In various implementations, access traffic steering, switching and splitting (ATSSS) may be supported by a user equipment (UE) and/or a fifth generation core network (5GC). ATSSS enables a multi-access (MA) protocol data unit (PDU) (MA-PDU) session which can exchange one or more PDUs between the UE and a data network by simultaneously using a third generation partnership project (3GPP) and a non-3GPP access network. The UE may request a MA-PDU session when the UE is registered via both 3GPP access and non-3GPP access or when the UE is registered via only one access.

A functionality of an ATSSS-capable UE to steer, switch and/or split the MA-PDU session traffic across 3GPP access and non-3GPP access, is called a “steering functionality”. An ATSSS-capable UE may support one or more of the following types of steering functionalities: high-layer steering functionalities, which operate above an internet protocol (IP) layer; or low-layer steering functionalities, which operate below the IP layer. Each steering functionality in the UE enables traffic steering, switching and/or splitting across 3GPP access and non-3GPP access, in accordance with one or more ATSSS rules provided by a network which may include one or more of: active-standby; smallest delay; load-balancing; and/or priority-based traffic steering, switching and/or splitting across 3GPP access and non-3GPP access etc., for example.

A steering mode indicator, which indicates that the UE may change one or more default steering parameters, may be provided in a steering mode component. The UE may adjust the traffic steering based on its own decisions. One of the following examples of the steering mode indicators may be provided: autonomous load-balance indicator, used when the steering mode is load-balancing; or UE-assistance indicator, used when the steering mode is load-balancing, for example.

In an implementation, after the establishment of the MA PDU session, the UE may receive a prioritized list of one or more ATSSS rules from a session management function (SMF). Examples of various structures of one or more ATSSS rules are shown in Table 1.

TABLE 1

| | | | SMF permitted to | |
|---|---|---|---|---|
| Information | | | modify in a PDU | |
| name | Description | Category | context | Scope |
| Rule identifier | Unique identifier to identify the | Mandatory | No | PDU context |
| | ATSSS Rule | | | |
| Rule | Determines the order in which | Mandatory | Yes | PDU context |
| Precedence | the ATSSS rule is evaluated in | (NOTE 1) | | |
| | the UE. | | | |
| Traffic | This part defines the Traffic | Mandatory | | |
| Descriptor | descriptor components for the | (NOTE 2) | | |
| | ATSSS rule. | | | |
| Application | One or more application | Optional | Yes | PDU context |
| descriptors | identities that identify the | | | |
| | application(s) generating the | | | |
| | traffic (NOTE 3). | | | |
| IP descriptors | One or more 5-tuples that | Optional | Yes | PDU context |
| (NOTE 4) | identify the destination of IP | | | |
| | traffic. | | | |
| Non-IP | One or more descriptors that | Optional | Yes | PDU context |
| descriptors | identify the destination of non- | | | |
| (NOTE 4) | IP traffic, e.g. of Ethernet | | | |
| | traffic. | | | |
| Access | This part defines the Access | Mandatory | | |
| Selection | Selection Descriptor | | | |
| Descriptor | components for the ATSSS | | | |
| | rule. | | | |
| Steering Mode | Identifies the steering mode | Mandatory | Yes | PDU context |
| | that should be applied for the | | | |
| | matching traffic and associated | | | |
| | parameters. | | | |
| Steering Mode | Indicates either autonomous | Optional | Yes | PDU context |
| Indicator | load-balance operation or UE- | (NOTE 6) | | |
| | assistance operation if steering | | | |
| | mode is set to “Load | | | |
| | Balancing”. | | | |
| Threshold | A Maximum RTT and/or a | Optional | Yes | PDU context |
| Values | Maximum Packet Loss Rate. | (NOTE 6) | | |
| Steering | Identifies whether the MPTCP | Optional | Yes | PDU context |
| Functionality | functionality or the ATSSS-LL | (NOTE 5) | | |
| | functionality should be applied | | | |
| | for the matching traffic. | | | |

NOTE 1:
Each ATSSS rule has a different precedence value from the other ATSSS rules.
NOTE 2:
At least one of the Traffic Descriptor components is present.
NOTE 3:
An application identity consists of an OSId and an OSAppId.
NOTE 4:
An ATSSS rule cannot contain both IP descriptors and Non-IP descriptors.
NOTE 5:
If the UE supports only one Steering Functionality, this component is omitted.
NOTE 6:
The Steering Mode Indicator and the Threshold Values shall not be provided together.

In an implementation, the UE evaluates a plurality of ATSSS rules in a priority order. Each ATSSS rule may include a traffic descriptor (including one or more components described in Table 1) that determines when the ATSSS rule is applicable. In an example, the ATSSS rule is determined to be applicable when every component in the traffic descriptor matches a considered service data flow (SDF).

Depending on a type of the MA PDU session, the traffic descriptor may include one or more of following components: for internet protocol (IP) (e.g., IPv4 or IPv6, or IPv4v6 type), one or more application descriptors and/or IP descriptors; or for Ethernet type, one or more application descriptors and/or non-IP descriptors, for example.

In an implementation, one ATSSS rule with a “match all” traffic descriptor may be provided, which matches all SDFs. When provided, this ATSSS rule may have least rule precedence value, so this ATSSS rule may be the last one evaluated by the UE. In an example, a format of the “match all” traffic descriptor of the ATSSS rule may be provided.

In an implementation, each ATSSS rule may include an access selection descriptor that includes and/or indicates the steering mode, which determines how the traffic of a matching SDF should be distributed across 3GPP and non-3GPP accesses.

In an implementation, one or more of the following steering modes may be supported: active-standby, smallest delay, load-balancing, or priority-based, for example.

The active-standby mode may be used to steer a SDF on one access (an active access), when this access is available, and to switch the SDF to the other available access (a standby access), when the active access becomes unavailable. When the active access becomes available again, the SDF is switched back to this access. In a non-limiting example, if the standby access is not defined, then the SDF may be only allowed on the active access and may not be transferred on another access.

The smallest delay may be used to steer a SDF to an access that is determined to have a smallest round-trip time (RTT). One or more measurements may be obtained by the UE and/or a user plane function (UPF) to determine the RTT over a 3GPP access and/or over a non-3GPP access. Additionally, if one access becomes unavailable, all SDF traffic is switched to the other available access. In an example, the smallest delay mode may only be used for a non-guaranteed bit rate (Non-GBR) SDF.

The load-balancing may be used to split a SDF across both accesses if both accesses are available. It may include a percentage of SDF traffic that should be sent over the 3GPP access and/or over the non-3GPP access. In an example, the load-balancing may only be applicable to the non-GBR SDF. Additionally, if one access becomes unavailable, all SDF traffic may be switched to the other available access, as if the percentage of the SDF traffic transported via the available access was 100%.

The priority-based mode may be used to steer all the traffic of an SDF to a high priority access, until this access is determined to be congested. In this case, the traffic of the SDF may also be sent to a low priority access, e.g. the SDF traffic may be split over the two accesses. In addition, when the high priority access becomes unavailable, all SDF traffic may be switched to the low priority access. A method by which the UE and/or the UPF determine when a congestion occurs on an access may be implementation-dependent. In an example, the priority-based mode may only be used for the non-GBR SDF.

In an implementation, the ATSSS rule may include a steering mode Indicator, which may indicate that the UE may change the one or more default steering parameters provided in the steering mode component and may adjust the traffic steering based on its own decisions. In an example, one of the following steering mode indicators may be provided: an autonomous load-balance indicator, or a UE-assistance indicator, for example.

The autonomous load-balance indicator may be provided only when the steering mode is load-balancing. When provided, the UE may ignore the percentages in the steering mode component (e.g. the default percentages provided by the network) and may autonomously determine its own percentages for traffic splitting, in a way that maximizes the aggregated bandwidth in the uplink direction. The UE is expected to determine its own percentages for traffic splitting by performing measurements across the two accesses. The UPF may apply a similar behavior when the autonomous load-balance indicator is included in an N4 rule.

The UE-assistance indicator may be provided only when the steering mode is load-balancing. When provided by the network, it indicates that the UE may decide how to distribute an uplink (UL) traffic of the matching SDF based on an internal state of the UE (e.g. when the UE is in a special internal state, e.g. lower battery level), and that the UE may inform the UPF how the UE decided to distribute the UL traffic of the matching SDF. In the normal cases, although with this indicator provided, the UE may distribute the UL traffic as indicated by the network.

In an implementation, the UE-assistance indicator may be provided for one or more SDFs for which the network has no strong steering requirements. For example, when the network has no strong steering requirements for default traffic of the MA PDU session, the network can indicate that this traffic must be steered with the load-balancing steering mode using 50%-50% split percentages, and/or that the UE is allowed to use other split percentages, such as 0%-100%, if this is needed by the UE to optimize its operation (e.g. to minimize its battery consumption), for example.

In an implementation, the ATSSS rule may include one or more threshold values. The one or more threshold values may be provided when the steering mode is priority-based and/or when the steering mode is load-balancing with a fixed split percentage (e.g. without an autonomous load-balance indicator and/or a UE assistance indicator etc., for example). In an example, a threshold value may be a value for RTT and/or a value for packet loss rate etc. The one or more threshold values are applicable to both accesses and are applied by the UE and/or the UPF.

In the load-balancing steering mode with fixed split percentages (e.g. without the autonomous load-balance indicator and/or the UE assistance indicator), when at least one measured parameter (e.g. the RTT and/or the packet loss rate etc., for example) on one access exceeds the provided threshold value, the UE and/or the UPF may stop sending traffic on this access, or may continue sending traffic on this access but may reduce the traffic on this access by an implementation-specific amount and may send the amount of reduced traffic on the other access. When all measured parameters (e.g. the RTT and/or the packet loss rate etc.) for both accesses do not exceed the provided threshold values, the UE and/or the UPF may apply the fixed split percentages.

In the priority-based steering mode, when the one or more threshold values are provided for the priority-based steering mode, these threshold values may be considered by the UE and/or the UPF to determine when an access becomes congested. In an example, when a measured parameter (e.g. the RTT and/or the packet loss rate etc.) on one access exceeds the provided threshold value, the UE and/or the UPF may consider this access as congested and send the traffic also to the low priority access.

In an implementation, the ATSSS rule may include a steering functionality, which may identify whether a multipath transmission control protocol (MPTCP) functionality and/or an ATSSS low layer (ATSSS-LL) functionality may be used to steer the traffic of the matching SDF. This may be used when the UE supports multiple functionalities for ATSSS.

In an example, there is no need to update the ATSSS rules when one access becomes unavailable or available.

In an example, one or more of the following ATSSS rules could be provided to UE: (a) “Traffic Descriptor: UDP, DestAddr 1.2.3.4”, “Steering Mode: Active-Standby, Active=3GPP, Standby=non-3GPP”: this rule means “steer UDP traffic with destination IP address 1.2.3.4 to the active access (3GPP), if available. If the active access is not available, use the standby access (non-3GPP)”; (b) “Traffic Descriptor: TCP, DestPort 8080”, “Steering Mode: Smallest Delay”: this rule means “steer TCP traffic with destination port 8080 to the access with the smallest delay”. The UE needs to measure the RTT over both accesses, in order to determine which access has the smallest delay; (c) “Traffic Descriptor: Application-1”, “Steering Mode: Load-Balancing, 3GPP=20%, non-3GPP=80%”, “Steering Functionality: MPTCP”: this rule means “send 20% of the traffic of Application-1 to 3GPP access and 80% to non-3GPP access by using the MPTCP functionality”; and/or (d) “Traffic Descriptor: Application-1”, “Steering Mode: Load-Balancing, 3GPP=20%, non-3GPP=80%, “Threshold Value for Packet Loss Rate: 1%”, “Steering Functionality: MPTCP”: this rule means “send 20% of the traffic of Application-1 to 3GPP access and 80% to non-3GPP access as long as the Packet Loss Rate does not exceed 1% on both accesses, by using the MPTCP functionality. If the measured Packet Loss Rate of an access exceeds 1%, then the traffic of Application-1 may be reduced on this access and sent via the other access”.

In an implementation, one or more power classes are provided for UE for frequency range 1 (FR1) and frequency range 2 (FR2). The one or more power classes are specified based on the assumption of certain UE types with specific device architectures, as shown in Table 2.

TABLE 2

| UE Power class | UE type |
|---|---|
| 1 | Fixed wireless access (FWA) UE |
| 2 | Vehicular UE |
| 3 | Handheld UE |
| 4 | High power non-handheld UE |
| 5 | Fixed wireless access (FWA) UE |
| 6 | High Speed Train Roof-Mounted UE |
| 7 | RedCap UE |

Note:
RedCap variants of non-RedCap UEs are not precluded

In an example, for one or more UEs using FR1, power class 2 and power class 3 are applicable as shown in Table 3. In an example, FR1 uses frequencies below 7.125 GHz and FR2 uses frequencies above 24.250 GHz. In an example, power class 3 is a default power class. In an example, different power classes may be used for different bands in FR1 and FR2.

TABLE 3

| Class | Max Output Power | Operating Band |
|---|---|---|
| Power Class 2 | 26 dBm | n41, n77, n78, n79 |
| Power Class 3 | 23 dBm | All bands within FR1 |

In an implementation, a base station (e.g., a gNB) has transmit power of up to 80 W, and a UE is limited to 23 dBm (or 200 mWatts which maps to the default power class 3). This results in a power imbalance between the gNB and the UE. This may be compensated by greater receiver sensitivity on the gNB but may lead to situations where the UE receives a relatively good signal from the gNB (e.g., a reference signal received power (RSRP) and/or a reference signal received quality (RSRQ) etc.) but has little or no power margin on an uplink. When the UE is power limited, one or more uplink transmissions are degraded leading to increased interference and degraded cell edge performance.

When an ATSSS capable UE is in a power limited state, it can result in degradation of cell performance. Debugging such conditions is very difficult and complicated. Many of the UE capabilities to support ATSSS functionalities such as UE detecting unavailability and/or availability of an access, the UE using the UE-assistance indicator in an ATSSS rule, the UE determining when congestion occurs etc. are UE implementation dependent.

In an implementation, when the gNB detects that the UE is reaching an uplink power limit, the gNB may notify the 5GC to update the UE and/or the UPF specific ATSSS policies, for example, if the 3GPP access should be continued to be prioritized for data transmission.

In order to detect the UE reaching the uplink power limit, the gNB needs to have a measure of an uplink power budget. A power headroom (PHR) report indicates a remaining transmission power for the UE to use in addition to the power being used by the current transmission.

Power Headroom (PHR)=UE Max Transmission Power−PUSCH Power=Pₘₐₓ−P_{pusch}

If the PHR value is positive, the UE can transmit more data.

If the PHR value is negative, the UE is transmitting above allowed limit.

The PHR is a type of media access control (MAC) control element (MAC CE) that reports the headroom between the current UE transmission (Tx) power (estimated power) and a nominal power. There are 2 triggers for PHR (which are specified in one or more radio resource control (RRC) messages): path loss change greater than certain threshold, and/or periodic timer, for example.

The gNB can use the PHR report value to estimate how much uplink bandwidth the UE can use for a specific subframe. Since the more resource blocks a UE is using, the higher UE Tx power gets, but the UE Tx power should not exceed the max power defined in a specification and/or regulation etc. If the UE does not have enough power headroom, it cannot use additional bandwidth (resource block).

Using one or more PHR thresholds as entry and exit criteria, the gNB may determine when the UE is in power limited state and notify the 5GC to dynamically update the ATSSS rules for the UE and the UPF. Further, the gNB may use additional parameters such as hysteresis and/or time to trigger to further refine the determination.

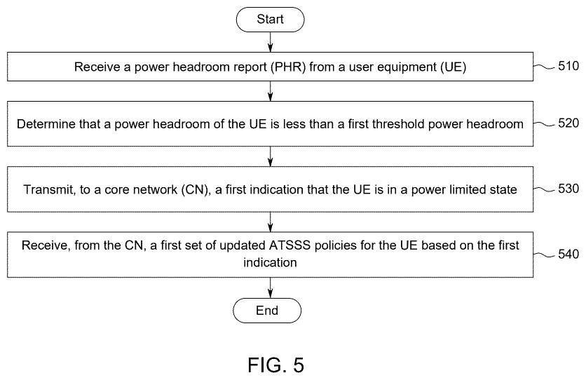

Referring now to FIG. 5, a flowchart illustrating a process for an ATSSS trigger for a power limited UE is shown according to one or more embodiments. The process may be performed by a base station (e.g., a gNB).

At 510, the gNB receives the PHR from the UE. Based on the received PHR, the gNB determines the power headroom of the UE. The UE is associated with a set of ATSSS policies. In an implementation, the UE is connected to the 5GC by the 3GPP access and the non-3GPP access. The UE is associated with the MA PDU session using the 3GPP access and the non-3GPP access. In an implementation, the gNB receives, from the UE, an indication for one or more of: the UE is ATSSS-enabled UE, or the UE uses the UE-assistance indicator for adjusting traffic. In an implementation, the gNB receives the PHR report from the UE using the MAC CE. In an implementation, PHR reporting is triggered by one or more of: a path loss change greater than a threshold path los change, or a periodic timer event.

At 520, the gNB determines that the PHR is less than a first threshold PHR.

At 530, the gNB transmits, to the 5GC, a first indication that the UE is in a power limited state. In an implementation, the gNB determines that the UE is in the power limited state based on a PHR trigger event. In an implementation, the power headroom of the UE is monitored for a predefined duration. In an implementation, the gNB determines that the UE enters the power limited state when the power headroom is less than the first threshold power headroom for the predefined duration. In an implementation, the gNB determines that the UE exits the power limited state when the power headroom is not less than the first threshold power headroom for the predefined duration.

At 540, the gNB receives, from the 5GC, a first set of updated ATSSS policies for the UE based on the first indication. In an implementation, the first set of updated ATSSS policies prioritize the non-3GPP access when the UE is in the power limited state. The gNB transmits the first set of updated ATSSS policies to the UE.

Alternatively, and/or additionally, the gNB may determine that the power headroom is not less than the first threshold PHR. The gNB may transmit, to the 5GC, a second indication that the UE is not in the power limited state. The gNB may receive a second set of updated ATSSS policies for the UE based on the second indication. The gNB transmits the second set of updated ATSSS policies to the UE.

In an example, the gNB transparently receives and/or transmits one or more NAS messages. The one or more NAS messages may include the first set of updated ATSSS policies and/or the second set of updated ATSSS policies.

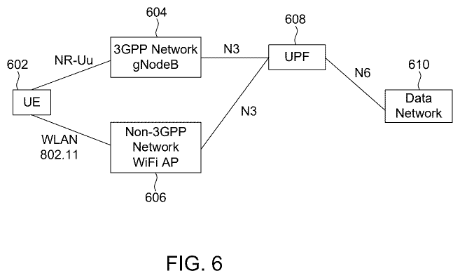

Referring now to FIG. 6, an example system diagram of an ATSSS architecture is shown according to one or more embodiments. The ATSSS architecture includes a UE 602, a gNB 604 (in a 3GPP network), an access point (AP) 606 (in a non-3GPP network), a UPF 608, and a data network (DN) 610. The UE 602 may be in communication with the gNB 604 by way of a NR-Uu access, e.g., a 3GPP access. The UE 602 may be in communication with the AP 606 by way of a WiFi (802.11) access, e.g., a non-3GPP access. In an example, the UE 602 may be an ATSSS capable UE. In an example, the UE 602 may use a set of ATSSS policies for transmission and/or reception of data (to/from the gNB 604 and/or the AP 606) over the 3GPP access and the non-3GPP access individually and/or simultaneously.

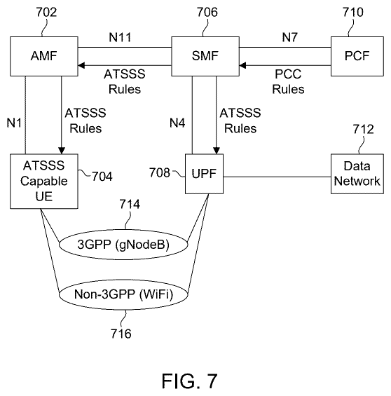

Referring now to FIG. 7, an example flow diagram of a method of transmitting a set of ATSSS policies to a UE is shown according to one or more embodiments. An example ATSSS architecture includes an AMF 702, a UE 704, an SMF 706, a UPF 708, a PCF 710, and a DN 712. The UE 704 may be in communication with the UPF 708 by way of a 3GPP access through a gNB 714 and a non-3GPP access through an AP 716. The UE 704 may be an ATSSS capable UE. The UE 704 is in communication with the AMF 702 via an N1 interface, and the UE 704 may receive a set of ATSSS policies and/or a set of updated ATSSS policies from the AMF 702.

For transmitting data in an uplink direction, e.g., from the UE 704 to the DN 712, an ATSSS function in the UE 704 may manage a set of ATSSS rules/policies.

For transmitting data in a downlink direction, e.g., from the DN 712 to the UE 704, an ATSSS function in the UPF 708 may manage a set of ATSSS rules/policies.

In an implementation, the gNB 714 may detect that the UE 704 is power limited. If the gNB 714 detects that the UE 704 is power limited, the gNB 714 sends an indication to 5GC that the UE 704 is power limited. The PCF 710 may generate one or more new PCC rules for the UE 704. The SMF 706 may generate a set of updated ATSSS rules/policies for the UE 704 and/or the UPF 708. The SMF 706 may send the set of updated ATSSS rules/policies for uplink to the UE 704 via the AMF 702 over an N11 interface to be sent to the UE 704 as a NAS message over the N1 interface. The SMF 706 may send the set of updated ATSSS rules/policies for downlink to the UPF 708 over an N4 interface.

If the gNB 714 detects that the UE 704 is no longer power limited, e.g. the gNB 714 detects that the UE 704 has exited the power limited state, the gNB 714 may send indication to the 5GC that UE 704 is no longer power limited. The PCF 710 may generate the updated/new set of PCC rules for the UE 704. The SMF 706 may generate the updated/new set of ATSSS rules/policies for the UE 704 and the UPF 708. The SMF 706 may send the updated/new ATSSS rules/policies for uplink to the UE 704 via the AMF 702 over the N11 interface to be sent to the UE 704 as a NAS message over the N1 interface. The SMF 706 may send the new/updated set of ATSSS rules/policies for downlink to the UPF 708 over the N4 interface.

Typically, the ATSSS as a feature has no impact on an access network. It only impacts the UE and the CN. In an implementation, an ATSSS capable UE and an ATSSS capable 5GC (e.g., the AMF, the SMF, the UPF and/or the PCF etc.) may be required for implementing one or more techniques of this disclosure. The 3GPP RAN (e.g. the gNB) and the non-3gpp access (e.g. the WLAN, WiFi, e.g. 802.11) are not impacted and/or aware that one or more ATSSS capabilities are being leveraged. In one or more techniques of the present disclosure, the gNB may detect a power state of the UE and may trigger, initiate and/or facilitate in updating the ATSSS rules/policies, thereby increasing the efficiency of the communication with the UE.

In an example, the 3gpp access network may be 5G RAN (with the gNB) or may also be 6G RAN with newer to be determined node. The 5GCore (with the AMF, the SMF, the UPF, and/or the PCF etc.) can also be a 6GCore with newer to be determined network functions.

What is claimed is:

1. A method performed by a base station, the method comprising:
receiving a power headroom report (PHR) from a user equipment (UE), wherein the UE is associated with a set of access traffic steering, switching and splitting (ATSSS) policies;
determining, based on the received PHR, a power headroom of the UE;
on a condition that the determined power headroom is less than a first threshold power headroom, transmitting, to a core network (CN), a first indication that the UE is in a power limited state; and
receiving, from the CN, a first set of updated ATSSS policies for the UE based on the first indication.

2. The method of claim 1, further comprising:
transmitting the first set of updated ATSSS policies to the UE.

3. The method of claim 1, further comprising:
on a condition that the determined power headroom is not less than the first threshold power headroom, transmitting, to the CN, a second indication that the UE is not in the power limited state; and
receiving a second set of updated ATSSS policies for the UE based on the second indication.

4. The method of claim 3, further comprising:
transmitting the second set of updated ATSSS policies to the UE.

5. The method of claim 1, wherein the PHR is received using a media access control (MAC) control element (MAC CE).

6. The method of claim 3, further comprising:
monitoring the power headroom of the UE for a predefined duration.

7. The method of claim 6, further comprising:
determining that the UE enters the power limited state when the power headroom is less than the first threshold power headroom for at least the predefined duration.

8. The method of claim 6, further comprising:
determining that the UE exits the power limited state when the power headroom is not less than the first threshold power headroom for at least the predefined duration.

9. The method of claim 1, further comprising receiving, from the UE, an indication for one or more of:
the UE is ATSSS-enabled UE, or
the UE uses a UE-assistance indicator for adjusting traffic.

10. A base station, comprising:
a transceiver; and
a processor, wherein the transceiver and the processor are configured to:
receive a power headroom (PHR) from a user equipment (UE), wherein the UE is associated with a set of access traffic steering, switching and splitting (ATSSS) policies,
determine, based on the received PHR, a power headroom of the UE,
on a condition that the determined power headroom is less than a first threshold power headroom, transmit, to a core network (CN), a first indication that the UE is in a power limited state, and
receive, from the CN, a first set of updated ATSSS policies for the UE based on the first indication.

11. The base station of claim 10, wherein the transceiver and the processor are further configured to:
transmit the first set of updated ATSSS policies to the UE.

12. The base station of claim 10, wherein the transceiver and the processor are further configured to:
on a condition that the determined power headroom is not less than the first threshold power headroom, transmit, to the CN, a second indication that the UE is not in the power limited state, and
receive a second set of updated ATSSS policies for the UE based on the second indication.

13. The base station of claim 12, wherein the transceiver and the processor are further configured to:
transmit the second set of updated ATSSS policies to the UE.

14. The base station of claim 10, wherein the PHR is received using a media access control (MAC) control element (MAC CE).

15. The base station of claim 12, wherein the transceiver and the processor are further configured to:
monitor the power headroom of the UE for a predefined duration.

16. The base station of claim 15, wherein the transceiver and the processor are further configured to:
determine that the UE enters the power limited state when the power headroom is less than the first threshold power headroom for the predefined duration.

17. The base station of claim 15, wherein the transceiver and the processor are further configured to:
determine that the UE exits the power limited state when the power headroom is not less than the first threshold power headroom for the predefined duration.

18. The base station of claim 10, wherein the transceiver and the processor are further configured to:
receive, from the UE, an indication for one or more of:
the UE is ATSSS-enabled UE, or
the UE uses a UE-assistance indicator for adjusting traffic.
